(19) United States
(12) Patent Application Publication
(10) Pub. No.: US 2024/0218100 A1
(43) Pub. Date: Jul. 4, 2024

(54) CATALYST COMPOSITIONS THAT HAVE MODIFIED ACTIVITY AND PROCESSES TO MAKE THEM

(71) Applicant: Dow Global Technologies LLC, Midland, MI (US)

(72) Inventors: Kishori Deshpande, Pearland, TX (US); Ian M. Munro, Lake Jackson, TX (US)

(21) Appl. No.: 18/550,687

(22) PCT Filed: Jun. 1, 2022
(86) PCT No.: PCT/US2022/031696

§ 371 Date: Sep. 15, 2023

Related U.S. Application Data
(60) Provisional application No. 63/209,212, filed on Jun. 10, 2021.

(51) Int. Cl. C08F 210/16

(52) U.S. Cl. CPC C08F 210/16

(57) ABSTRACT

Granular polyolefin polymerization catalyst exhibit activation with less activity spikes if the composition has substantial zones of exposed support material and substantial zones of exposed activator, rather than a core-shell morphology. This morphology can be achieved by forming a complex of the catalyst material and the activator before depositing the activator on the support material.

### TECHNICAL FIELD

This application relates to the field of catalyst compositions to produce polyolefin polymers, and processes to make them.

### BACKGROUND

It is known to make granular catalyst compositions that contain a catalyst component, an activator and a support material and that are useful for polymerizing olefin monomers. It is further known to use spray drying processes to make them. (For clarity, materials referred to as “catalysts” in the polyolefin industry are generally consumed in the polymerization reaction and end up incorporated into the polymer that they catalyze.)

Spray-dried catalyst compositions usually form a “core shell” structure that contains particles having (1) a core of the support material; and (2) a shell of the catalyst and the activator that substantially covers the support material. This common structure is described in the following references:

Granular catalyst compositions, especially the compositions that contain high-activity catalysts, sometimes experience a short period of extremely high activity (spike) when the catalyst is introduced into the reactor. After the spike, catalyst activity settles down to lower levels until the reaction is complete. The activity spike causes a large, localized increase in the temperature of the reaction. The high temperature can melt the polymer as it is formed and cause it to form polymer sheets and chunks in the reactor.

Compositions are needed that can smoothly achieve consistent activity rates while minimizing activity spikes.

### SUMMARY

We have discovered that the initial spike in catalyst activity can be reduced by forming a granular catalyst composition that has discreet zones of exposed support material and discrete zones of exposed activator. The zones can be in the form of separate particles of support material and activator or in the form of particles that combine a zone of agglomerated activator adhered to a zone of exposed support material. These catalyst compositions can be made by forming a complex of the catalyst component and the activator, before combining with the support material and making the granular catalyst composition. The invention is especially useful with high-activity catalysts.

One aspect of the present invention is a granular catalyst composition that comprises:
a) between 20 and 75 weight percent of a support material;
b) between 25 and 80 weight percent of an activator that is (i) in separate particles from the support material and/or (ii) attached to the support material in zones such that substantial surface areas of both the support material and the activator remain exposed; and
c) a catalyst component that is capable of initiating and catalyzing the polymerization of olefin polymers, which catalyst component is adhered to or embedded in the support material and/or the activator in a quantity sufficient to initiate and catalyze the polymerization of olefin polymers,
   wherein all weight percentages are based on the aggregate weight of the support material, activator and catalyst without regard to the weight of other components in the composition.

A second aspect of the present invention is a granular catalyst composition that comprises:
a) between 20 and 75 weight percent of a support material;
b) between 25 and 80 weight percent of an activator; and
c) a catalyst component that is capable of initiating and catalyzing the polymerization of olefin polymers in a quantity sufficient to initiate and catalyze the polymerization of olefin polymers,
   wherein the composition contains a mixture of different particles in which (i) some of the different particles comprise primarily the support material on their surface and (ii) others of the different particles comprise primarily the activator on their surface, such that substantial surface area of both the activator and the support material is exposed, and wherein catalyst component is adhered to or embedded in the support material and/or the activator and wherein all weight percentages are based on the total weight of the support material, activator and catalyst without regard to the weight of other components, if any, in the composition.

A third aspect of the present invention is a process to make a catalyst composition, which process comprises the steps of:
a) Forming a complex of (i) a catalyst component that is capable of initiating and catalyzing the polymerization of olefin polymers and (ii) an activator for the catalyst component in the absence of substantial support material;
b) Forming a suspension or solution that contains the complex from step (a) and a support material in a solvent; and
c) Spray drying the suspension from step (b) to form a granular composition that contains the support material, the catalyst component and the activator, under conditions such that the activator forms agglomerated zones that leave substantial surface area of both the support material and the activator exposed.

A fourth aspect of the present invention is a process to make a polyolefin polymer comprising the step of contacting olefin monomer with the catalyst composition of the present invention or a catalyst composition made by the process of the present invention under conditions such that the olefin monomer is polymerized to form a polymer.

### BRIEF DESCRIPTION OF DRAWINGS

FIG. 1 compares the internal reactor temperature and ethylene uptake (consumption) in a reactor that is making ethylene-hexene copolymer using two different versions of a catalyst composition from Catalyst 101 (described hereinafter). One version is the granular catalyst composition of Inventive Example 1 (IE 1) and this illustrates the compositions of the present invention. The other version is a conventional catalyst composition of Comparative Example 1 (CE 1) is a comparative example with ordinary core shell morphology.

### DETAILED DESCRIPTION

Granular catalyst compositions of the present invention contain:
a) a support material;
b) an activator (sometimes called an “activating catalyst” or a “co-catalyst”); and
c) a catalyst component.

Appropriate support materials, activators and catalyst components are known, and it is known how to select the appropriate catalysts, activators and support materials to make a desired polymer under desired reactor conditions.

The catalyst component comprises at least one catalyst that is capable of initiating and catalyzing the polymerization of olefin polymers. In many embodiments, the catalyst in the catalyst component is suitable for initiating and catalyzing the polymerization of ethylene monomer, either alone or in combination with one or more olefin comonomers, to make a polyethylene homopolymer or copolymer. Known catalysts frequently contain a catalytic metal, such as titanium, vanadium, zirconium or hafnium. Two well-known families of catalysts for polymerization of olefin monomers are conventional Ziegler-Natta catalysts and single-site catalysts. In single site catalysts, the catalytic metal is held in a complex with one or more organic ligands.

The catalyst component may contain a conventional Ziegler Natta catalyst, in which the catalytic metal is optionally titanium with magnesium or vanadium, and in many embodiments is titanium with magnesium. The catalytic metal is in an inorganic salt, such as a halide. Exemplary catalyst components for a Ziegler Natta composition include TiCl₂ and TiCl₄. Conventional transition metal catalyst compounds based on magnesium/titanium electron-donor complexes that are useful in the invention are described in U.S. Pat. Nos. 4,302,565 and 4,302,566. The MgTiCl (ethyl acetate)₄ derivative is one such example. British Patent Application 2,105,355 describes various conventional vanadium catalyst compounds. Non-limiting examples of conventional vanadium catalyst compounds include vanadyl trihalide, alkoxy halides and alkoxides such as VOC1₃, VOC1₂ (OBu) where Bu=butyl and VO(OC₂H₃)₃; vanadium tetra-halide and vanadium alkoxy halides such as VC1₄ and VC1₂(OBu); vanadium and vanadyl acetyl acetonates and chloroacetyl acetonates such as V(AcAc)₃ and VOC1₂(AcAc) where (AcAc) is an acetyl acetonate. Examples of conventional vanadium catalyst compounds are VOC1₃, VC1₄ and VOC1 OR where R is a hydrocarbon radical, such as a C₂ to C₁₀ aliphatic or aromatic hydrocarbon radical such as ethyl, phenyl, isopropyl, butyl, propyl, n-butyl, iso-butyl, tertiary-butyl, hexyl, cyclohexyl, naphthyl, etc. and vanadium acetyl acetonates. Other examples of conventional Ziegler-Natta catalyst components are described in U.S. Pat. No. 8,012,903 B2.

The catalyst component may contain a metallocene catalyst, which is a single-site catalyst in which a catalytic metal is complexed to one or more cyclopentadienyl groups. The catalytic metal may be, for example, titanium, zirconium or hafnium, and in many examples, it is zirconium or hafnium. The catalytic metal is generally in the form of a salt (such as a halide) or a metal alkyl. The cyclopentadienyl ligands may be simply cyclopentadiene or may be substituted with one or more organic or inorganic substituents. The cyclopentadienyl ligand may comprise a single cyclopentadienyl ring, or it may comprise two or more rings linked by one or more bridging moieties. Many suitable options are described in detail in US Patent Publication 2018/0134821A, Paragraphs 81-109. Examples of suitable metallocene catalyst components are described in the following U.S. Pat. Nos. 5,672,669; 7,989,564 B2; and in US Patent Application: 2006/0293470 A1

An exemplary metallocene catalyst and process to make it are described the PCT Patent Application WO 2019/190897 A1 (Page 5, compound xxxvi) and in Huang, Rubin et al, 41(3) Macromolecules 579-590 (2008). It is named (propylcyclopentadienyl)-(tetramethylcyclopentadienyl)zirconium dichloride and has the following structure:

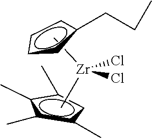

For this application, this compound is called Catalyst 101.

The catalyst component may contain a non-metallocene single-site catalyst. In non-metallocene single site catalysts, a catalytic metal is often complexed with a polydentate organic ligand. The catalytic metal may be, for example, titanium, zirconium or hafnium, and in many examples the catalytic metal is zirconium or hafnium. The catalytic metal is usually in the form of a salt (such as a halide) or a metal alkyl. The polydentate organic ligand has two or more complexing sites that are arranged such that the catalytic metal atom can form a complex linkage with more than one complexing site at the same time. Each complexing site optionally comprises an atom having unshared electron pairs, such as oxygen or nitrogen or other group 15 or 16 atoms. Examples of polydentate ligand and single site catalysts made from them are described in the following U.S. Pat. Nos. 6,489,263 B2; 6,723,808 B2 (col. 11-13); 7,718,566 B2; 7,989,564 B2; 9,637,567B2; 9,718,900 B2 and RE41,785 and in WO 2017/05898A1.

An exemplary non-metallocene single site catalyst is illustrated below.

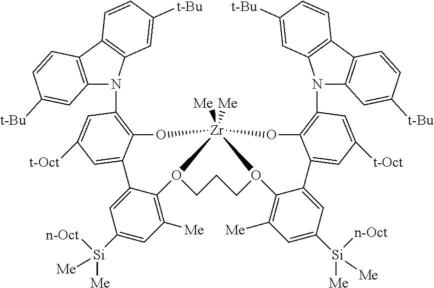

wherein t-Bu refers to a tertiary butyl group, t-Oct refers to a tertiary octyl group, n-Oct refers to a linear octyl group, and Me refers to a methyl group. For the purposes of this application, this catalyst is referred to as Catalyst 601. The ligand can be produced as described in WO 2017/05898A1 and complexed with zirconium or hafnium by known techniques.

The catalyst component may comprise a single catalyst as described above, or it may comprise two or more catalysts. If the catalyst component comprises more than one catalyst, the catalysts may be selected from the same group of catalysts (Ziegler Natta, metallocene, single-site non-metallocene) or may be selected from different groups. In some examples, the catalyst component may include a Ziegler Natta catalyst and a metallocene catalyst, or a Ziegler Natta catalyst and a non-metallocene single site catalyst, or a metallocene catalyst and a non-metallocene single site catalyst.

Granular catalyst compositions of this invention also contain an activator. Common activators are described in U.S. Pat. No. 6,723,808 B2 (col. 1-2). Many common activators are Lewis Acids. For example, the activator is optionally an organic aluminum compound and in many embodiments is an alumoxane compound. Examples of alumoxanes include alkylalumoxanes which include methylalumoxane (MAO), modified methylalumoxane (MMAO), ethylalumoxane and isobutylalumoxane.

Alumoxane activators are typically sold as powders. For ease of processing and use, some activators have a particle size from 1 to 15 micrometers, or from 1 to 10 micrometers, before they are used in the process of this invention.

Granular catalyst compositions of this invention also contain a support material. The support material may be inorganic or organic; in many embodiments it is inorganic. The support material may be porous or nonporous. Exemplary support materials are oxides or halides of Group 2, 3, 4, 5, 13 and 14 elements. For example, support materials may include silica, alumina, silica-alumina, magnesium chloride, graphite, and mixtures thereof. Other useful support materials include magnesia, titania and zirconia. In certain exemplary embodiments, combinations of the support materials may be used, including, but not limited to, combinations such as silica-chromium, silica-alumina, silica-titania, and the like. Organic support materials include polymers such as polyvinylchloride, substituted polystyrene, functionalized or crosslinked organic support materials such as polystyrene divinyl benzene polyolefins or polymeric compounds, and mixtures thereof, and graphite, in any of its various forms. Additional support materials may include porous acrylic polymers described in EP 0 767 184 B1. 0229.

Silica and fumed silica are common support materials. Useful silicas and fumed silicas are commercially available under the trade name “Cab-O-Sil”.

In many embodiments, the support material has an average particle length (in the largest dimension) of less than about 10 micrometers or less than about 1 micrometer, or has an average particle length in the range of from about 0.001 to about 0.1 micrometers.

The optimum ratios of catalyst, activator and support material in the catalyst composition will vary depending on the components selected and the intended use of the catalyst.

When the catalyst is a single site catalyst and the activator is a hydrocarbyl aluminum oxide, the mole ratio of aluminum atoms (from the activator) to catalyst metal atoms (from the catalyst) is optionally at least 10 or at least 50 or at least 100; and the mole ratio of aluminum atoms (from the activator) to catalyst metal atoms (from the catalyst) is optionally at most 5000 or at most 1000 or at most 500.

The granular catalyst composition contains from 20 weight percent to 75 weight percent of support material, based on the total weight of the catalyst, activator and support material. The amount of support material in the granular catalyst composition is optionally at least 25 percent by weight or at least 30 percent by weight or at least 35 weight percent or at least 40 weight percent, based on the total weight of the catalyst, activator and support material. The amount of support material in the granular catalyst composition is optionally at most 70 percent by weight or at most 65 percent by weight, based on the total weight of the catalyst, activator and support material.

The granular catalyst composition contains from 25 weight percent to 80 weight percent of activator, based on the total weight of the catalyst, activator and support material. The amount of activator in the granular catalyst composition is optionally at least at least 30 percent by weight or at least 35 percent by weight, based on the total weight of the catalyst, activator and support material. The amount of activator in the granular catalyst composition is optionally at most 75 percent by weight or at most 65 percent by weight or at most 60 percent by weight, based on the total weight of the catalyst, activator and support material.

The granular catalyst composition contains enough of the catalyst component to initiate and catalyze polymerization of olefin monomers. The appropriate amount varies depending on the catalyst component(s), the monomers to be polymerized and the polymerization conditions. In many embodiments, the catalyst component makes up at least 1 weight percent of the granular catalyst composition or at least 2 weight percent or at least 3 weight percent, based on the weight of the support material, activator and catalyst component. In many embodiments, the catalyst component makes up at most 30 weight percent of the granular catalyst composition or at most 20 weight percent or at most 15 weight percent, based on the weight of the support material, activator and catalyst component.

The forgoing proportions are based on the combined weight of catalyst, activator and support material only and ignoring other components, such as any solvent.

The granular composition of the present invention is made up of particles. In some embodiments the composition contains a mixture of support material particles whose surface area (whether exposed or not) comprises primarily support material and activator particles whose surface area (whether exposed or not) comprises primary activator. In some embodiments, the composition comprises blended particles in which the surface of individual particles has substantial surface area of both support material and activator. In some embodiments, the composition may comprise all three types of particles: support material particles and activator particles and blended particles.

In granular catalyst compositions of this invention, the activator does not form a continuous shell on a core of support material. Instead, granular catalyst compositions of this invention have substantial zones of the support material exposed and substantial zones of activator exposed. This morphology can be achieved by having separate individual particles of support material and activator. Alternatively, this morphology can be achieved by having zones or particles of activator adhered to the surface of support material particles, so that substantial surface area of both the support material and the activator remains exposed. Alternatively, both embodiments may be present—the catalyst composition will contain separate particles of support material and activator, as well as particles of support material and activator that are attached to each other.

The amount of activator surface area that is exposed should be sufficient to permit the granular catalyst composition to effectively initiate and catalyze polymerization of olefinic monomers. The amount of support material surface area that is exposed should be sufficient to reduce excessive catalyst activity when the granular catalyst composition is introduced in the polymerization reactor.

In some embodiments, more than 10 percent of the exposed surface area of particles in the granular composition is support material, or at least 20 percent, or at least 30 percent or at least 40 percent or at least 50 percent or at least 60 percent, based on the total surface area of support material and activator and excluding other components. In some embodiments, at most 90 percent of the exposed surface area of particles in the granular composition is support material, or at most 80 percent, based on the based on the total surface area of support material and activator and excluding other components. Conversely, in some embodiments at least 10 percent of the exposed surface area of particles in the granular composition is activator, or at least 20 percent, based on the based on the total surface area of support material and activator and excluding other components. In some embodiments, less than 90 percent of the exposed surface area of particles in the granular composition is activator, or at most 80 percent, or at most 70 percent or at most 60 percent or at most 50 percent or at most 40 percent, based on the total surface area of support material and activator and excluding other components.

In some embodiments, the granular catalyst composition contains separate particles whose surface area is primarily activator and separate particles whose surface area is primarily support material. In some of these embodiments, the particles whose surface area is primarily activator make up at least 10 percent of the particles, or at least 20 percent, based on the based on the total particles of support material and activator and excluding other components. In some embodiments, the particles whose surface area is primarily activator make up at most 90 percent of the particles, or at most 80 percent, or at most 70 percent or at most 60 percent or at most 50 percent or at most 40 percent, based on the total particles of support material and activator and excluding other components. Conversely in some of these embodiments, the particles whose surface area is primarily support material make up at least 10 percent of the particles, or at least 20 percent, or at least 30 percent or at least 40 percent or at least 50 percent or at least 60 percent, based on the total particles of support material and activator and excluding other components. In some embodiments, the particles whose surface area is primarily support material make up at most 90 percent of the particles, or at most 80 percent, based on the total particles of support material and activator and excluding other components.

Relative proportions of particles and surface areas can be estimated by scanning electron microscopy of the granular catalyst composition.

The catalyst component is adhered to or embedded in the activator or the support material or both. We hypothesize, without intending to limit this application, that in many embodiments the catalyst component is primarily adhered to or embedded in the activator.

The granular catalyst composition can be made by the process of:
a) Forming a complex of (i) a catalyst component that is capable of initiating and catalyzing the polymerization of olefin polymers and (ii) an activator for the catalyst component in the absence of substantial support material;
b) Forming a suspension or solution that contains the complex from step (a) and a support material in a solvent; and
c) Spray drying the suspension from step (b) to form a granular composition that contains the support material, the catalyst component and the activator, under conditions such that the activator forms agglomerated zones that leave substantial surface area of the support material exposed.

In step (a), a complex of the catalyst component and the activator is made. The complex can be made by forming a solution or suspension of the catalyst component and the activator in a solvent. (This application uses the word “solvent” to describe the liquid medium, regardless of whether the solid components are dissolved in it or merely suspended in it.) The solvent is typically a material capable of dissolving or suspending the catalyst component and the activator. Examples of useful solvents include: hydrocarbons such as linear or branched alkanes including n-hexane, n-pentane and isopentane; aromatics such as toluene and xylene; and halogenated hydrocarbons such as dichloromethane. In some embodiments, the solvent has a boiling point from about 0 degrees to about 150 degrees Celsius.

The selected catalyst and activator are mixed in the solvent for a period of time sufficient for them to form a complex with each other. The ratios of activator and catalyst are normally the same as in desired catalyst composition. The optimum time period needed may vary based on the mixing conditions and the catalyst and activator selected. At room temperature, the blending time is optionally at least 5 minutes or at least 10 minutes or at least 20 minutes or at least 30 minutes. In many embodiments, blending over 1 or 2 hours is unnecessary but not harmful. After the complex is formed, it may be recovered, or it may be used for step (b) in the solution/suspension in which it was made.

We hypothesize that the unique morphology of the inventive catalyst materials arises from the formation of the catalyst-activator complex in the absence of substantial support material, before the support material is blended in and the spray drying is performed. By “absence of substantial support material” we mean that the solution or suspension does not contain enough support material to interfere substantially with forming the unique morphology of the inventive catalyst materials, alternatively the solution or suspension has no support material.

In step (b), the complex from step (a) is mixed with the support material in a suspension or solution in a solvent. The solvent and the blending time have the same limits and embodiments as listed for step (a) above. The solvent and blending time in step (b) may be the same or different from step (a). Optionally, additional activator and/or additional catalyst component may be added in this step. If added, the additional activator and/or additional catalyst component may be the same or different from the activator and/or catalyst component used in step (a).

The suspension and the resulting catalyst composition may optionally further contain an organic or inorganic compound as a binder so that particle integrity is further enhanced. The binder may also serve a second function, such as stabilizing the final polyolefin product against oxidation, or improving the gas phase fluidization of nascent polymer particles. Such compounds are well known in the art.

In step (c), the suspension or solution from step (b) is spray-dried to form the granular catalyst composition. For example, spray drying may be performed by spraying the suspension through a heated nozzle into a stream of heated inert drying gas to evaporate the solvent and produce solid particles that contain the catalyst, activator and support material. Examples of suitable drying gases include nitrogen, argon, or propane. The volumetric flow of the drying gas is frequently considerably larger than the volumetric flow of the suspension. Atomization of the suspension may be accomplished using an atomizing nozzle or a centrifugal high speed disc atomizer. Examples of suitable spray drying processes are described in U.S. Pat. Nos. 5,290,745 and 9,637,567B2 and US Application 2006/0293470 and in PCT Application WO 2019/190897 A1, and in Okuyama et al., Preparation of Functional Nanostructured Particles by Spray Drying, 17 Advanced Powder Tech. 587-611 (2006).

Variations in the process are also possible.
Some compositions of the present invention can optionally be made by separately spray-drying the support material and the complex of activator with catalyst component and then physically blending the resulting particles.
Some compositions of the present invention can optionally be made by (1) making conventional core-sell spray-dried catalysts with a shell of activator and catalyst component on a core of support material and then (2) blending the core-shell catalysts with spray-dried support material. In this case, the composition may comprise support material particles and activator particles as described previously, but the activator particles will have a surface that is predominantly activator and a core that is predominantly support material.

The resulting catalyst composition may be used in known olefin polymerization reactions. The polymerization is a polymerization of monomers that contain at least 50 mole percent ethylene, or at least 80 mole percent ethylene or at least 90 mole percent ethylene. The polymerized monomers may contain essentially 100 percent ethylene or may contain other comonomers. The comonomers are optionally linear α-olefins contains 3 to 12 carbon atoms, and are frequently selected from 1-butene, 1-pentene, 1-hexene, 1-heptene or 1-octene.

The polymerization may take place in a gas-phase, solution phase or slurry phase. The polymerization may take place in a single reactor or in a plurality of staged reactors. Such reactions are well-known. The polymerization reaction is optionally a gas-phase reaction, such as a single stage gas-phase polymerization.

In a gas phase polymerization process, a continuous cycle may be employed, wherein in one part of the cycle of a reactor system, a cycling gas stream, otherwise known as a recycle stream or fluidizing medium, is heated in the reactor by the heat of polymerization. This heat may be removed from the cycling gas stream in another part of the cycle by a cooling system external to the reactor. Generally, in a gas fluidized bed process for producing polymers, a gaseous stream containing one or more monomers may be continuously cycled through a fluidized bed in the presence of a catalyst under reactive conditions. The gaseous stream may be withdrawn from the fluidized bed and recycled back into the reactor. Simultaneously, polymer product may be withdrawn from the reactor and fresh monomer is added to replace the polymerized monomer. Gas phase polymerization process are described in more detail in, for example, U.S. Pat. Nos. 4,543,399, 4,588,790, 5,028,670, 5,317,036, 5,352,749, 5,405,922, 5,436,304, 5,453,471, 5,462,999, 5,616,661, and 5,668,228.

The reactor pressure in a gas phase process may vary, for example, from about atmospheric pressure to about 600 psig, or from about 100 psig (690 kPa) to about 500 psig (3448 kPa), or from about 200 psig (1379 kPa) to about 400 psig (2759 kPa), or from about 250 psig (1724 kPa) to about 350 psig (2414 kPa). The reactor temperature in a gas phase process may vary, for example, from about 30° C. to about 120° C., or from about 60° C. to about 115° C., or from about 70° C. to about 110° C., or from about 70° C. to about 95° C.

Additional examples of gas phase processes that may be used include those described in U.S. Pat. Nos. 5,627,242, 5,665,818 and 5,677,375, and European publications EP A-0 794 200, EP-A-0 802 202, EP-A2 0 891 990, and EP-B-634 421.

Embodiments of the polymerization process may include a slurry polymerization process. In the slurry polymerization process, pressures may range from about 1 to about 50 atmospheres and temperatures may range from about 0° C. to about 120° C. In a slurry polymerization, a suspension of solid, particulate polymer may be formed in a liquid polymerization diluent medium to which ethylene and comonomers and often hydrogen along with catalyst are added. The suspension including diluent may be intermittently or continuously removed from the reactor where the volatile components are separated from the polymer and recycled, optionally after a distillation, to the reactor. The liquid diluent employed in the polymerization medium may typically be an alkane having from 3 to 7 carbon atoms, and in many embodiments is a branched alkane. The medium employed should be liquid under the conditions of polymerization and relatively inert. When a propane medium is used the process should be operated, for example, above the reaction diluent critical temperature and pressure. In some embodiments, a hexane or an isobutane medium is employed.

Embodiments of the polymerization process may include a solution polymerization process, which is also well-known. In general, a solution phase polymerization process occurs in one or more well-stirred reactors such as one or more loop reactors or one or more spherical isothermal reactors at a temperature in the range of from 120° C. to 300° C.; for example, from 160° C. to 215° C., and at pressures in the range of from 300 psi to 1500 psi; for example, from 400 psi to 750 psi. The residence time in solution phase polymerization process is typically in the range of from 2 to 30 minutes (min); for example, from 10 to 20 min. Ethylene, one or more solvents, one or more catalyst systems, and optionally one or more comonomers are fed continuously to the one or more reactors. Exemplary solvents include, but are not limited to, isoparaffins. For example, such solvents are commercially available under the name Isopar E from ExxonMobil Chemical Co. The resultant mixture of the ethylene based polymer and solvent is then removed from the reactor and the ethylene based polymer is isolated. Solvent is typically recovered via a solvent recovery unit, i.e. heat exchangers and vapor liquid separator drum, and is then recycled back into the polymerization system. Examples of solution phase polymerization are described in Patent Application WO 2017/058981 A1.

Catalyst compositions of the present invention exhibit a smoother activation than catalysts with conventional core-shell morphology, as measured by internal reactor temperature.

### NUMBERED EMBODIMENTS

The following illustrative embodiments show some possible embodiments of the invention.

1. A granular catalyst composition that comprises:
a) between 20 and 75 weight percent of a support material;
b) between 25 and 80 weight percent of an activator that is (i) in separate particles from the support material and/or (ii) attached to the support material in zones such that substantial surface areas of both the support material and the activator remain exposed; and
c) a catalyst component that is capable of initiating and catalyzing the polymerization of olefin polymers, which catalyst component is adhered to or embedded in the support material and/or the activator in a quantity sufficient to initiate and catalyze the polymerization of olefin polymers,
wherein all weight percentages are based on the aggregate weight of the support material, activator and catalyst without regard to the weight of other components in the composition.

2. A granular catalyst composition that comprises:
a) between 20 and 75 weight percent of a support material;
b) between 25 and 80 weight percent of an activator; and
c) a catalyst component that is capable of initiating and catalyzing the polymerization of olefin polymers in a quantity sufficient to initiate and catalyze the polymerization of olefin polymers,
wherein the composition contains a mixture of different particles in which (i) some of the different particles comprise primarily the support material on their surface and (ii) others of the different particles comprise primarily the activator on their surface, such that substantial surface area of both the activator and the support material is exposed, and wherein catalyst component is adhered to or embedded in the support material and/or the activator and wherein all weight percentages are based on the total weight of the support material, activator and catalyst without regard to the weight of other components, if any, in the composition.

3. A process to make a catalyst composition, which process comprises the steps of:
a) Forming a complex of (i) a catalyst component that is capable of initiating and catalyzing the polymerization of olefin polymers and (ii) an activator for the catalyst component in the absence of substantial support material;
b) Forming a suspension or solution that contains the complex from step (a) and a support material in a solvent; and
c) Spray drying the suspension from step (b) to form a granular composition that contains the support material, the catalyst component and the activator, under conditions such that the activator forms agglomerated zones that leave substantial surface area of both the support material and the activator exposed.

4. The process of Embodiment 3 wherein the suspension that is spray-dried comprises from 2 to 20 weight percent catalyst, from 30 to 75 weight percent activator, and from 25 to 70 weight percent support material.

5. The invention is any of Embodiments 1-4 wherein the catalyst comprises a metallocene catalyst.

6. The invention in any of Embodiments 1-4 wherein the catalyst comprises a non-metallocene single site catalyst.

7. The invention in any of Embodiments 1-6 wherein the catalyst comprises titanium, zirconium or hafnium.

8. The invention in any of Embodiments 1-7 wherein the activator comprises an alumoxane compound.

9. The invention in any of Embodiments 1-8 wherein the support material comprises a silicate.

10. The invention in any of Embodiments 1-9 wherein at least 10 percent of the exposed surface area of particles in the granular composition is activator and more than 10 percent of the exposed surface area is support material.

11. The invention in any of Embodiments 1-10 wherein at least 20 percent of the exposed surface area of particles in the granular composition is activator and at least 30 percent of the exposed surface area is support material.

12. The invention in any of Embodiments 1-11 wherein at least 40 percent of the exposed surface area of particles in the granular composition is support material.

13. The invention in any of Embodiments 1-12 wherein the granular catalyst composition comprises at least 10 percent particles whose surface area is primarily activator and at least 20 percent particles whose surface area is primarily support material.

14. The invention in any one of Claims 1-13 wherein the granular catalyst composition comprises particles whose surface comprises substantial surface areas of both support material and activator.

15. The invention in any of Embodiments 1-14 wherein the granular catalyst composition comprises from 2 to 20 weight percent catalyst component, from 30 to 75 activator and from 25 to 70 weight percent support material, based on the aggregate weight catalyst, activator and support material and excluding other components in the composition.

16. A process to make a polyolefin polymer comprising the step of polymerizing one or more unsaturated olefin monomers in the presence of a catalyst composition under conditions suitable to initiate and maintain the polymerization reaction, wherein the catalyst composition is a composition of any of Embodiments 1 or 4-15 or is made in a process of any of Embodiments 2-15.

17. The process of Embodiment 16 wherein the monomers comprise 80 to 100 weight percent ethylene monomer and 0 to 20 weight percent of a comonomer selected from the group of 1-butene, 1-pentene, 1-hexene, 1-heptene or 1-octene.

### Test Methods

In this document, particle size, activator surface area and support material surface area for the granular catalyst composition are observed by scanning electron microscopy using an FEI Nova NanoSEM 630 scanning electron microscope at an accelerating voltage of 10.0 Kev. Standard detectors in the equipment can distinguish between aluminum-containing and silicon-containing surfaces on the particles through energy dispersive x-ray spectroscopy (EDS), and can thus provide false-color images of the particles that show where support material and activator are present on the surfaces of the particles.

### EXAMPLES

### Inventive Example 1 (IE 1): Metallocene Catalyst Composition

A 17.83 g quantity of a homogenous slurry of 12.4 wt % solid methylalumoxane (MAO) in heptane (5 m Average Particle Size (APS), from Tosoh Corporation, Japan) is added to a 40 ml glass vial. A 0.146 g of Catalyst 101 is added to the vial, and the contents are stirred overnight. The slurry is filtered on a frit, rinsed with toluene, and dried under vacuum at ambient temperature. A 2.3 g quantity of yellow solids are recovered. The yellow solids comprise the complex of the catalyst component (Catalyst 101) and the activator (MAO).

The recovered solids are mixed in a slurry with Cabosil and modified methylalumoxane (MMAO-3A) in a solvent heptane according to the recipe shown in Table 1, thereby forming a suspension or solution that contains the complex (made above) and a support material (Cabosil) and MMAO-3A in a solvent (heptane). The slurry is spray dried in a Büchi mini spray dryer (Model B-290) as shown in Table 1. The spray dryer is operated at inlet temperature 140° C. and the outlet temperature was set at 75° C. The feed pump speed is set at 130 rpm and the aspirator was set at 50%. The total recovery for the process is 64 wt % of a granular composition (Inventive Example 1) that contains the support material, the catalyst component and the activator, under conditions such that the activator forms agglomerated zones that leave substantial surface areas of both the support material and the activator exposed.

Comparative Example 1 (CE 1): A comparative example is also made using Catalyst 101 that is not complexed with activator.

TABLE 1

| | Inventive | | Comparative |
|---|---|---|---|
| | Example | | Example |
| | 1 (IE 1) | | 1 (CE 1) |
| Forming Complex (step a)) | | | |
| Mol Zr atoms/g | 5.1E−05 | | Not applicable |
| Catalyst 101 | | | |
| Catalyst 101, g | 0.146 | | Not applicable |
| MAO, (12.4 wt % in | 17.83 | g | Not applicable |
| heptane) | | | |
| Recovered Complex, g | 2.3 | | Not applicable |
| Forming Slurry (step b); to be | | | |
| used in Spray Drying step c)) | | | |
| Recovered Complex, g | 2.3 | | 0 |
| Catalyst 101 Added | 0 | g | 0.1 g (at 5.1E−05 |
| | | | mol Zr atom/g |
| | | | Catalyst 101) |

| | | |
|---|---|---|
| Cabosil, g | 2.6 | 2.65 |
| MMAO solution (g) | 12.9 (18.16 wt % | 22 (10 wt. % |
| | MMAO in heptane) | in toluene) |
| MAO (10 wt % in toluene), | 0 | 22 |
| g | | |
| Solvent (g) | 64.4 (heptane) | 75 (toluene) |

The granular catalyst composition of IE 1 is used to polymerize ethylene monomer and n-1-hexene in a 2 L stirred bed gas phase lab polymerization reactor under the following standard conditions shown in Table 2:

TABLE 2

| Temperature (° C.) | 100 (80 at start) |
|---|---|
| Pressure (psi) | 230 |
| C₆/C₂ ratio | 0.004 |
| H₂/C₂ ratio | 0.0016 |
| Run time (h) | 1 |

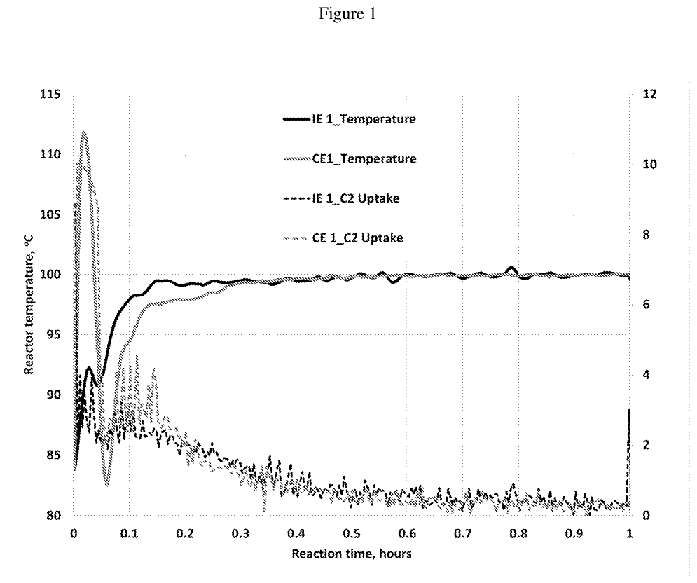

FIG. 1 shows the internal reactor temperature and ethylene consumption over time for the Inventive Example 1 versus the same data for Comparative Example 1.

### Inventive Example 2 (IE 2): Non-Metallocene Single Site Catalyst Composition

Catalyst 601 is made by the following process: The ligand of Formula A is prepared as described in WO 2017/058,981, and the entire contents of WO 2017/058,981 are incorporated herein by reference.

In a glove box, a 16 oz oven-dried glass jar is charged with zirconium tetrachloride [ZrCl₄] (15.0 g, 64.1 mmol) and toluene (300 mL; available from Fisher Scientific) and a magnetic stir bar. The contents of the jar are cooled to approximately −30 degrees Celsius (° C.). Methylmagnesium bromide (56.6 mL of 2.6M solution in diethyl ether, 147 mmol; available from Millipore Sigma) is added and the solution is stirred for 15 minutes at −30° C. The jar is charged with a ligand of Formula A (56.00 g, 35.9 mmol).

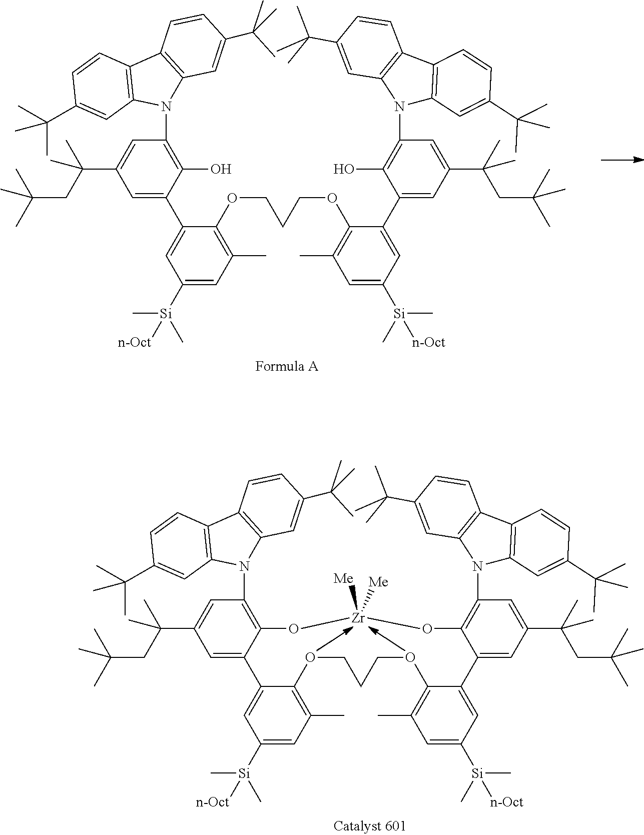

As used herein, “Me” refers to methyl, “n-Oct” refers to n-C₈H₁₇, and “n-Pr” refers to n-C₃H₇.

The contents of the vial are allowed to stir for 3 hours as the solution is gradually warmed to room temperature. The mixture is filtered, and the solvent is removed in vacuo from the filtrate to obtain a gray powder (45 g, 71.0% yield). The presence of Catalyst 601 can be confirmed by 1H NMR analysis. 1H NMR (400 MHz, Benzene-d6) δ 8.19 (d, 2H), 8.01 (s, 2H), 7.99 (d, 2H), 7.87 (d, 2H), 7.79 (d, 2H), 7.65 (d, 2H), 7.57 (d, 2H), 7.51 (dd, 2H), 7.30 (dd, 2H), 7.04 (m, 2H), 3.57 (m, 2H), 3.43 (m, 2H), 1.79 (d, 2H), 1.67 (d, 2H), 1.60 (s, 18H), 1.46 (s, 6H), 1.42 (s, 6H), 1.35 (s, 6H), 1.34-1.25 (m, 26H), 1.25 (s, 18H), 0.94 (t, 6H), 0.93 (s, 18H), 0.60 (m, 4H), 0.11 (s, 6H), 0.08 (s, 6H), −0.63 (s, 6H).

A 25.1 g quantity of a homogenous slurry of 12.4 wt % solid methylalumoxane in heptane (5 m Average Particle Size (APS), from Tosoh Corporation, Japan) is added to a 40 ml glass vial. A 0.9 g of Catalyst 601 is added to the vial, and the contents are stirred overnight. The slurry is filtered on a frit, rinsed with toluene, and dried under vacuum at ambient temperature. A 4 g quantity of yellow solids are recovered. The yellow solids comprise the complex of the catalyst component (Catalyst 601) and the activator (MAO). The recovered solids are mixed in a slurry with Cabosil and modified methylalumoxane (MMAO-3A) in heptane according to the recipe shown in Table 3, thereby forming a suspension or solution that contains the complex (made above) and a support material (Cabosil) and MMAO-3A in a solvent (heptane). The slurry is spray dried in a Büchi mini spray dryer (Model B-290). The spray dryer is operated at inlet temperature 140° C. and the outlet temperature is set at 75° C. The feed pump speed was set at 130 rpm and the aspirator was set at 50%. The total recovery for the process is 64 wt % of a granular composition (Inventive Example 2) that contains the support material, the catalyst component and the activator, under conditions such that the activator forms agglomerated zones that leave substantial surface areas of both the support material and the activator exposed.

Comparative Example 2 (CE 2): A comparative example is also made using Catalyst 601 that is not complexed with activator.

TABLE 3

Inventive Example 2 (IE 2)

Forming Complex (step a))

| | |
|---|---|
| Mol Zr atoms/g Catalyst 601 | 5.0E−05 |
| Catalyst 601, g | 0.9 |
| MAO, (12.4 wt % in heptane) | 25.1 |
| Recovered Complex, g | 4 |

Forming Slurry (step b), to be used
in Spraying Dry step c))

| | |
|---|---|
| Recovered Complex, g | 4 |
| Cabosil, g | 2.6 |
| MMAO solution (g) | 22.1 (18.16 wt % MMAO) |
| Solvent (g) | 56.9 (heptane) |

The inventive granular catalyst composition of IE 2 and the comparative catalyst of CE 2 are used in a polymerization as described for Inventive Example 1, except the reaction temperature is about 90° C. With the inventive granular catalyst composition, the internal reactor temperature rises from about 75° C. to about 90° C. in the first 0.2 hour and remains at about 90° C. for the remainder of the first hour. With the comparative catalyst, the internal reactor temperature rises from about 75° C. to about 190° C. in the first 0.1 hour, drops to about 120° C. at the 0.2 hour mark, and further drops to and remains below 50° C. by shortly after the 0.4 hour mark.

1. A granular catalyst composition that comprises:
a) between 20 and 75 weight percent of a support material;
b) between 25 and 80 weight percent of an activator that is (i) in separate particles from the support material and/or (ii) attached to the support material in zones such that substantial surface areas of both the support material and the activator remain exposed; and
c) a catalyst component that is capable of initiating and catalyzing the polymerization of olefin polymers, which catalyst component is adhered to or embedded in the support material and/or the activator in a quantity sufficient to initiate and catalyze the polymerization of olefin polymers,
wherein the total weight percentage of the support material, activator and catalyst equals 100 percent without regard to the weight of other components, if any, in the composition;
wherein the granular catalyst composition is made by forming a complex of the catalyst component and the activator, before combining with the support material and making the granular catalyst composition;
wherein the granular catalyst composition has discreet zones of exposed support material and discrete zones of exposed activator, wherein the particles combine a zone of agglomerated activator adhered to a zone of exposed support material.

2. A granular catalyst composition that comprises:
a) between 20 and 75 weight percent of a support material;
b) between 25 and 80 weight percent of an activator; and
c) a catalyst component that is capable of initiating and catalyzing the polymerization of olefin polymers in a quantity sufficient to initiate and catalyze the polymerization of olefin polymers,
wherein the composition contains a mixture of different particles in which (i) some of the different particles comprise primarily the support material on their surface and (ii) others of the different particles comprise primarily the activator on their surface, such that substantial surface area of both the activator and the support material is exposed, and wherein catalyst component is adhered to or embedded in the support material and/or the activator and wherein the total weight percentage of the support material, activator and catalyst equals 100 percent without regard to the weight of other components, if any, in the composition; and
wherein the granular catalyst composition is made by forming a complex of the catalyst component and the activator, before combining with the support material and making the granular catalyst composition;
wherein the granular catalyst composition has discreet zones of exposed support material and discrete zones of exposed activator, wherein the zones are in the form of separate particles of support material and separate particles of activator.

3. A process to make the granular catalyst composition of claim 1, which process comprises the steps of:
a) Forming a complex of (i) a catalyst component that is capable of initiating and catalyzing the polymerization of olefin polymers and (ii) an activator for the catalyst component in the absence of substantial support material;
b) Forming a suspension that contains the complex from step (a) and a support material in a solvent; and
c) Spray drying the suspension from step (b) to form a granular catalyst composition that contains the support material, the catalyst component and the activator, under conditions such that the activator forms agglomerated zones that leave substantial surface areas of both the support material and the activator exposed.

4. The process of claim 3 wherein the suspension that is spray-dried comprises from 2 to 20 weight percent catalyst, from 30 to 75 weight percent activator, and from 25 to 70 weight percent support material; wherein the total weight percentage of the support material, activator and catalyst equals 100 percent without regard to the weight of other components, if any, in the suspension.

5. The invention is claim 1 wherein the catalyst component comprises a metallocene catalyst.

6. The invention in claim 1 wherein the catalyst component comprises a non-metallocene single site catalyst.

7. The invention in claim 1 wherein the catalyst comprises titanium, zirconium or hafnium.

8. The invention in claim 1 wherein the activator comprises an alumoxane compound.

9. The invention in claim 1 wherein the support material comprises a silicate.

10. The invention in claim 1 wherein at least 10 percent of the exposed surface area of particles in the granular composition is activator and more than 10 percent of the exposed surface area of particles is support material; or wherein at least 20 percent of the exposed surface area of particles in the granular composition is activator and at least 30 percent of the exposed surface area of particles is support material; or wherein at least 40 percent of the exposed surface area of particles in the granular composition is support material; and/or wherein the granular catalyst composition comprises at least 10 percent particles whose surface area is primarily activator and at least 20 percent particles whose surface area is primarily support material; wherein the particle size, activator surface area and support material surface area for the granular catalyst composition are observed by scanning electron microscopy using a FEI Nova NanoSEM 630 scanning electron microscope at an accelerating voltage of 10.0 Kev.

11. The invention in claim 1 wherein the granular catalyst composition comprises particles whose surface comprises substantial surface areas of both support material and activator.

12. The invention in claim 1 wherein the granular catalyst composition comprises from 2 to 20 weight percent catalyst component, from 30 to 75 activator and from 25 to 70 weight percent support material, wherein the total weight percentage of catalyst, activator and support material equals 100 percent and without regard to any other components in the composition.

13. A process to make a polyolefin polymer comprising the step of polymerizing one or more unsaturated olefin monomers in the presence of a catalyst composition under conditions suitable to initiate and maintain the polymerization reaction, wherein the catalyst composition is a composition of claim 1.

14. The process of claim 13 wherein the monomers comprise 80 to 100 weight percent ethylene monomer and 0 to 20 weight percent of a comonomer selected from the group of 1-butene, 1-pentene, 1-hexene, 1-heptene or 1-octene.
